(19) United States
(12) Patent Application Publication
(10) Pub. No.: US 2025/0320102 A1
(43) Pub. Date: Oct. 16, 2025

(54) CHILD-RESISTANT SAFETY CAP REMOVAL TOOL

(71) Applicant: CVS Pharmacy, Inc., Woonsocket, RI (US)

(72) Inventor: Chih-Jen Leu, East Brunswick, NJ (US)

(21) Appl. No.: 18/632,598

(22) Filed: Apr. 11, 2024

(51) Int. Cl. B67B 7/18

(52) U.S. Cl. CPC B67B 7/18

(57) ABSTRACT

A safety cap removal tool including an ergonomic and user-friendly arrangement that allows for the removal of an outermost cap of a child-resistant safety cap bottle with reduced effort. The safety cap removal tool includes a baseplate, a nest block attached to the baseplate, and a pivot arm pivotally attached to the baseplate. The tool includes a receiving area disposed between a clamping surface of the pivot arm and the nest block. When the child-resistant safety cap bottle is placed cap-side down against the baseplate the pivot arm is then moved into contact with the child-resistant safety cap where a lip of the pivot arm engages with an edge of the outermost cap. In this position, the bottle is then moved in a direction away from the lip, pivoting at an area adjacent the nest block, separating the outermost cap from the remaining portion of the child-resistant safety cap.

### BACKGROUND

Child-resistant safety packaging is generally designed to lower the risk of children, or other high-risk individuals, easily accessing the contents of certain containers. More specifically, child-resistant safety packaging is employed on containers that hold medication, hazardous liquids, medications, chemicals, cleaning products, or other materials that are deemed to be dangerous to a child or other person when misused (e.g., ingested, handled, etc.).

In the United States, the U.S. Consumer Product Safety Commission (“CPSC”) is tasked with regulating child-resistant packaging in accordance with the Poison Prevention Packaging Act. These regulations include requiring child-resistant packaging for prescription medications, over-the-counter drugs, and the like. Some child-resistant safety caps include a two-piece cap design. This two-piece cap may include an innermost cap that is threaded to a bottle and an outermost cap that is coupled to the innermost cap. The outermost cap is allowed to generally rotate freely unless engaged with the innermost cap by, for example, applying downward pressure to the outermost cap. This applied pressure forces protrusions inside the outermost cap to engage with receiving features on the innermost cap, allowing torque to be transmitted from the outermost cap to the innermost cap which then causes the innermost cap to be loosened from or tightened to the bottle.

Although child-resistant packaging is intended to make accessing a container difficult for children, the packaging is also designed to allow access by adults with limited tactile abilities, arthritis, and/or other physical disabilities. While considerations of accessibility for these types of adults is important, the safety of children is paramount and takes precedence in the design of child-resistant packaging. As a result, some child-resistant packaging can be difficult to open by both adults and children.

### BRIEF SUMMARY

It is with respect to the above issues and other problems that the examples presented herein were contemplated. The present disclosure provides a child-resistant safety cap removal tool that allows a user to quickly remove an outermost cap from a multiple-piece (e.g., two-piece) child-resistant safety cap with minimal mechanical or physical effort. By removing the outermost cap from the multiple-piece child-resistant safety cap, the bottle can be easily opened by twisting only the innermost cap from the bottle. Stated another way, the present disclosure provides a safety cap removal tool that is capable of converting a bottle with a child-resistant safety cap into a bottle with a single-piece screw-on cap by, for instance, separating the outermost cap of the child-resistant safety cap from the innermost cap of the child-resistant safety cap attached to the bottle.

In one aspect, a safety cap removal tool includes a baseplate, comprising: a first side; a second side that is offset from the first side by a width of the baseplate; and a contact surface arranged between the first side and the second side; a nest block attached to the baseplate adjacent the first side; a pin attached to the baseplate adjacent the second side of the baseplate; a pivot arm comprising an arm length, the arm length extending from a pivot end of the pivot arm to a handle end of the pivot arm, the pivot arm pivotally engaged with the pin at the pivot end of the pivot arm, wherein the handle end of the pivot arm is arranged outside of a periphery of the baseplate at the first side, and wherein a receiving space is arranged between the pivot arm and the nest block; and a lip extending from a surface of the pivot arm into the receiving space; wherein the pivot arm is moveable about the pin between an open state of the pivot arm and a closed state of the pivot arm, wherein, in the open state of the pivot arm, the pivot arm is spaced apart from the nest block by a first distance, wherein, in the closed state of the pivot arm, the pivot arm is spaced apart from the nest block by a second distance, and wherein the second distance is less than the first distance.

Examples may include one of the following features, or any combination thereof. The safety cap removal tool, wherein the lip corresponds to a portion of a head of a screw that is attached to the pivot arm, and wherein the lip extends an engagement distance from the surface of the pivot arm. Aspects of the above safety cap removal tool may include a thumbscrew engaged with the baseplate at a point between the first side and the second side, wherein a body portion of the thumbscrew engages with a slot disposed in a thickness of the pivot arm at a point between the pivot end of the pivot arm and a handle end of the pivot arm. Aspects of the above safety cap removal tool may include wherein, in the open state of the pivot arm, the body portion of the thumbscrew engages with a first end of the slot, wherein, in the closed state of the pivot arm, the body portion of the thumbscrew engages with a second end of the slot, and wherein the first end of the slot is disposed opposite the second end of the slot. Aspects of the above safety cap removal tool may include wherein the pin is a shoulder screw and wherein the pivot arm is captured relative to the baseplate by a head of the shoulder screw. Aspects of the above safety cap removal tool may include wherein the pivot arm further comprises: an aperture passing through the thickness of the pivot arm adjacent the handle end of the pivot arm. Aspects of the above safety cap removal tool may include wherein the nest block comprises a V-shaped recess, and wherein a circle arranged in the receiving space contacts a first surface of the V-shaped recess, a second surface of the V-shaped recess and the surface of the pivot arm when the pivot arm is in the open state of the pivot arm and when the pivot arm is in the closed state of the pivot arm. Aspects of the above safety cap removal tool may include wherein the circle coincides with an outer cylindrical surface of a child-resistant safety cap of a bottle disposed in the receiving space such that a top surface of the child-resistant safety cap of the bottle is arranged in direct contact with the contact surface of the baseplate. Aspects of the above safety cap removal tool may include wherein the child-resistant safety cap of the bottle comprises: an innermost cap that threadedly engages with the bottle; and an outermost cap that selectively engages with the innermost cap, wherein the engagement distance is sized to a dimension that is less than or equal to a thickness of a wall of the outermost cap. Aspects of the above safety cap removal tool may include wherein, when the child-resistant safety cap of the bottle is arranged in contact with the contact surface, the pivot arm, and the nest block, the lip is arranged in contact with the outermost cap, and the bottle and the innermost cap are unrestricted by the safety cap removal tool. Aspects of the above safety cap removal tool may include wherein the thumbscrew is rotatable between a first height and a second height that is configured to be set to a height of the outermost cap.

In another aspect, a safety cap removal tool includes a baseplate comprising a width extending from a first side of the baseplate to a second side of the baseplate and a height extending from a third side of the baseplate to a fourth side of the baseplate; a nest block attached to a surface of the baseplate, the nest block arranged adjacent the first side of the baseplate and the third side of the baseplate; a pivot arm comprising a length extending from a pivot end of the pivot arm to an actuation end of the pivot arm, the pivot arm rotationally engaged with the baseplate at a pivot disposed at the pivot end of the pivot arm, wherein the pivot is arranged adjacent the second side of the baseplate; a safety cap receiving space disposed between the pivot arm and the nest block, the safety cap receiving space inset from the width of the baseplate a dimension from the first side and a dimension from the third side of the baseplate; and a lip extending a distance from the pivot arm into the safety cap receiving space, the distance corresponding to a wall thickness of an outermost cap of a child-resistant safety cap of a bottle.

Aspects of the above safety cap removal tool may include wherein the pivot arm is moveable between an open position relative to the nest block and a closed position relative to the nest block, wherein, an area of the safety cap receiving space in the open position is greater than an area of the safety cap receiving space in the closed position. Aspects of the above safety cap removal tool may include wherein the safety cap receiving space defines clamping surfaces of the safety cap removal tool corresponding to the surface of the pivot arm and at least one surface of the nest block. Aspects of the above safety cap removal tool may include wherein the clamping surfaces are configured to contact a cylindrical surface of the outermost cap of the child-resistant safety cap of the bottle at least at opposite sides of the cylindrical surface when the outermost cap of the child-resistant safety cap of the bottle is disposed in the safety cap receiving space and in contact with the surface of the baseplate. Aspects of the above safety cap removal tool may include wherein the lip is a portion of a head of a screw that is attached to the pivot arm. Aspects of the above safety cap removal tool may include wherein the actuation end of the pivot arm comprises an aperture that passes completely through a thickness of the pivot arm.

In yet another aspect, a method of removing an outermost cap from a child-resistant safety cap includes providing a safety cap removal tool, comprising: a baseplate comprising a width extending from a first side of the baseplate to a second side of the baseplate and a height extending from a third side of the baseplate to a fourth side of the baseplate; a nest block attached to a surface of the baseplate, the nest block arranged adjacent the first side of the baseplate and the third side of the baseplate; a pivot arm comprising a length extending from a pivot end of the pivot arm to an actuation end of the pivot arm, the pivot arm rotationally engaged with the baseplate at a pivot disposed at the pivot end of the pivot arm, wherein the pivot is arranged adjacent the second side of the baseplate; a receiving space disposed between the pivot arm and the nest block, the receiving space inset from the width of the baseplate a dimension from the first side and inset from the width of the baseplate a dimension from the third side of the baseplate; and a lip extending a distance from the pivot arm into the receiving space; positioning a child-resistant safety cap of a bottle into the receiving space of the safety cap removal tool such that a top surface of the child-resistant safety cap is disposed in contact with the surface of the baseplate and a cylindrical surface of the child-resistant safety cap of the bottle is disposed in contact with the nest block; causing the pivot arm to rotate about the pivot in a first direction and contact the cylindrical surface of the child-resistant safety cap of the bottle clamping the child-resistant safety cap of the bottle between the pivot arm and the nest block, wherein the lip extends the distance over a wall thickness of an outermost cap of the child-resistant safety cap of the bottle; and applying a force to the bottle such that the bottle and an innermost cap of the bottle separate from the outermost cap of the child-resistant safety cap of the bottle.

Aspects of the above method may include wherein, prior to causing the pivot arm to rotate, the method comprises: adjusting a height of the pivot arm relative to the baseplate via a thumbscrew engaged with the baseplate at a point between the first side of the baseplate and the second side of the baseplate, wherein a body portion of the thumbscrew engages with a slot disposed in a thickness of the pivot arm at a point between the pivot end of the pivot arm and the actuation end of the pivot arm. Aspects of the above method may include removing the outermost cap of the bottle from the receiving space of the safety cap removal tool; and causing the pivot arm to rotate about the pivot in a second direction opposite the first direction, releasing the outermost cap of the child-resistant safety cap of the bottle from the safety cap removal tool.

In some examples, the safety cap removal tool may be moved from an open state to a closed state. This movement may allow interaction between the safety cap removal and various sizes of child-resistant safety caps. The pivot arm of the safety cap removal tool may be restricted to movement between the open state and the closed state by one or more fasteners, pins, slots, and/or other features.

In one example, the pivot arm may include an aperture, handle, or other interface that allows a user or machine to cause rotation of the pivot arm relative to the baseplate of the safety cap removal tool. This handle area may be arranged at a distance offset from the pivot end of the pivot arm. The distance between the pivot end of the pivot arm and the handle end of the pivot arm is sized to provide a mechanical advantage that is capable of clamping an outermost cap of a child-resistant safety cap between the pivot arm and the nest block. When actuated by hand, this mechanical advantage results in a reduced effort on behalf of the user actuating the pivot arm of the safety cap removal tool. The pivot arm of the safety cap removal tool may be actuated by an automated system utilizing an actuator. For example, an air cylinder, solenoid, screw actuator, or other actuator may be operatively attached to the handle end of the pivot arm, causing the pivot arm to rotate about a pin at the pivot end of the pivot arm.

The preceding is a simplified summary of the disclosure to provide an understanding of some aspects of the disclosure. This summary is neither an extensive nor exhaustive overview of the disclosure and its various aspects, examples, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, examples, and configurations of the disclosure are possible utilizing, alone or in combination, one or more of the features set forth above or described in detail below. All examples and features mentioned above can be combined in any technically possible way.

Additional features and advantages are described herein and will be apparent from the following Detailed Description and the figures.

### BRIEF DESCRIPTION OF THE SEVERAL VIEWS OF THE DRAWINGS

FIG. 1 is a perspective view of a safety cap removal tool in accordance with examples of the present disclosure;

FIG. 2A is a perspective view of an example bottle with a child-resistant safety cap in accordance with examples of the present disclosure;

FIG. 2B is an exploded perspective view of the bottle with the child-resistant safety cap of FIG. 2A;

FIG. 2C is a front elevation view of the bottle with the child-resistant safety cap of FIG. 2A;

FIG. 2D is a front elevation section view of the bottle with the child-resistant safety cap taken through an axial center of the bottle taken through line “2D-2D” of FIG. 2A;

FIG. 2E is a detail section view of the bottle with the child-resistant safety cap taken from circle “2E” of FIG. 2D;

FIG. 3A is a top plan view of the safety cap removal tool in an open state in accordance with examples of the present disclosure;

FIG. 3B is a top plan view of the safety cap removal tool in a closed state in accordance with examples of the present disclosure;

FIG. 4A is a perspective view of the safety cap removal tool and bottle with the child-resistant safety cap in a first condition in accordance with examples of the present disclosure;

FIG. 4B is a perspective view of the safety cap removal tool and bottle with the child-resistant safety cap in a second condition in accordance with examples of the present disclosure;

FIG. 4C is a perspective view of the safety cap removal tool and bottle with the child-resistant safety cap in a third condition in accordance with examples of the present disclosure;

FIG. 4D is a detail side elevation section view of the safety cap removal tool and bottle with the child-resistant safety cap shown in FIG. 4C;

FIG. 4E is a detail side elevation section view of the safety cap removal tool and bottle with the child-resistant safety cap shown in FIG. 4D, in a first separation condition;

FIG. 4F is a perspective view of the safety cap removal tool in a fourth condition with the outermost cap of the child-resistant safety cap removed from the bottle in a second separation condition; and

FIG. 5 is a flow diagram of a method for removing an outermost cap from a child-resistant safety cap in accordance with examples of the present disclosure.

### DETAILED DESCRIPTION

Before any examples of the disclosure are explained, it is to be understood that the disclosure is not limited in its application to the details of construction and the arrangement of components set forth in the following description or illustrated in the following drawings. The disclosure is capable of other examples and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The claims of the instant application are not limited to the ornamental designs of the various articles and examples shown in the accompanying figures. Moreover, the figures are not intended to illustrate the only available ornamental designs of the various articles and examples described herein. As can be appreciated by a person having ordinary skill in the art, numerous alternative design options are available for the disclosed articles that could achieve the same functionality as described and/or claimed herein.

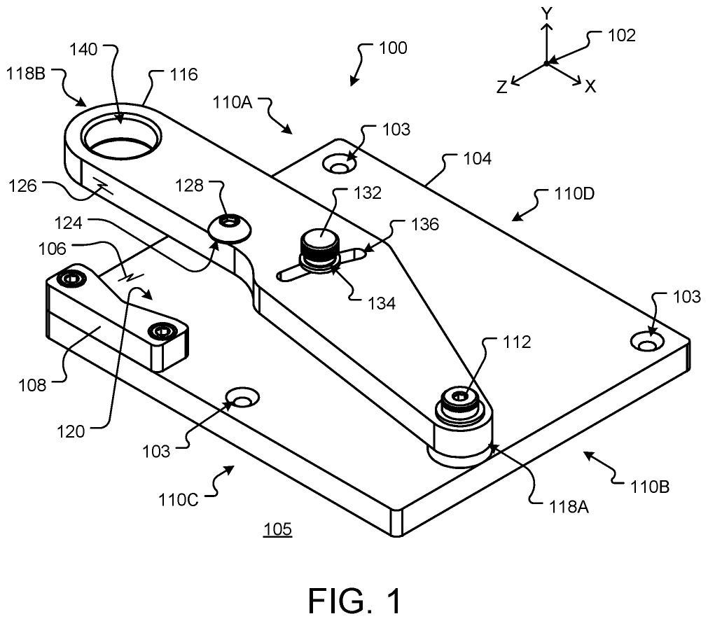

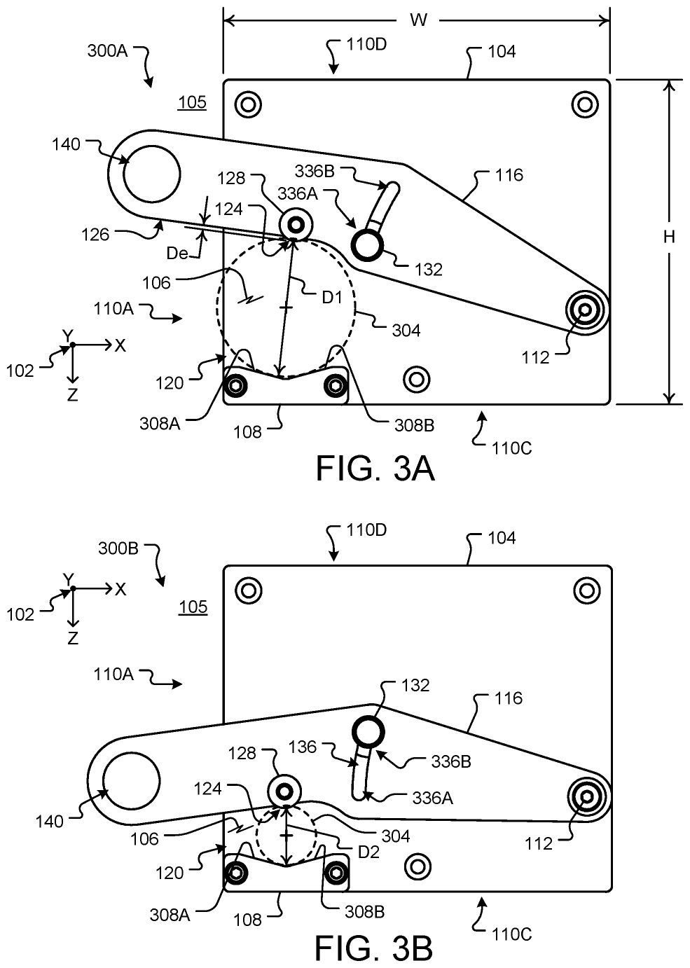

FIGS. 1 and 3A-3B show various views of the safety cap removal tool 100 in accordance with examples of the present disclosure. The safety cap removal tool 100 is shown in particular configurations (or shown to have a particular shape/design), but it should be appreciated that this is one of many possible configurations/shapes/designs. The safety cap removal tool 100 may be defined in terms of a first side 110A, a second side 110B, a third side 110C, and a fourth side 110D and/or with reference to a coordinate system 102. The coordinate system 102, as shown in any of the figures, includes three-dimensions comprising an X-axis, a Y-axis, and a Z-axis. Additionally or alternatively, the coordinate system 102 may be used to define planes (e.g., the XY-plane, the XZ-plane, and the YZ-plane) of the safety cap removal tool 100. These planes may be disposed orthogonally, or at 90 degrees, to one another. While the origin of the coordinate system 102 may be placed at any point on or near the components of the safety cap removal tool 100, for the purposes of description, the axes of the coordinate system 102 are always disposed along the same directions from figure to figure. In some examples, reference may be made to dimensions, angles, directions, relative positions, and/or movements associated with one or more components of the safety cap removal tool 100 with respect to the coordinate system 102. For instance, the width of the safety cap removal tool 100 may be defined as a dimension along the X-axis (shown as width, W, in FIG. 3A), the height of the safety cap removal tool 100 may be defined as dimension along the Z-axis (shown as height, H, in FIG. 3A), and a vertical dimension of the safety cap removal tool 100 may be defined as a dimension along the Y-axis of the coordinate system 102. Additionally or alternatively, the width of components of the safety cap removal tool 100 may be defined as a dimension along the X-axis, the height of the components of the safety cap removal tool 100 may be defined as dimension along the Z-axis, and the vertical dimension of the components of the safety cap removal tool 100 may be defined as a dimension along the Y-axis of the coordinate system 102.

The safety cap removal tool 100 is configured to remove the outermost cap of a child-resistant safety cap of a bottle. Removing the outermost cap from the child-resistant safety cap allows the bottle to be easily opened by users who have limited tactile abilities, arthritis, or other disabilities by unscrewing only the innermost cap from a bottle. In some examples, the safety cap removal tool 100 can be used to convert child-resistant safety bottles into non-child-resistant safety bottles for households without children. In any event, the safety cap removal tool 100 allows users who have no need for child-resistant safety features to open their important medication and/or other containers quickly and without pain or trouble.

The safety cap removal tool 100 may comprise a baseplate 104, a nest block 108, and a pivot arm 116. The baseplate 104 may comprise a first side 110A and a second side 110B that is offset from the first side 110A by a width, W, of the baseplate 104. The baseplate 104 includes a contact surface 106 that is arranged, for example, between the first side 110A and the second side 110B. The contact surface 106 may be configured to support a portion of the child-resistant safety cap of a bottle during operation of the safety cap removal tool 100. In some examples, the baseplate 104 may be mounted to a work surface 105 (e.g., table, countertop, tool holder) via one or more fasteners (e.g., screws, bolts, pins) located at one or more mount features 103. In one example, the mount features 103 may correspond to bolt holes, countersunk holes, counterbored holes, or the like. Continuing this example, where the mount features 103 are configured as countersunk holes, the safety cap removal tool 100 may be attached to a work surface 105 by flat-head screws that are inserted into the countersunk holes and screwed to the work surface 105 thereby clamping the baseplate 104 of the safety cap removal tool 100 against the work surface 105.

A nest block 108 is attached to the baseplate 104 adjacent the first side 110A (e.g., the left-hand side) and/or the third side 110C (e.g., the front side) of the baseplate 104. The nest block 108 may include a V-shaped recess comprising inclined surfaces that are configured to contact a cap of a child-resistant safety cap during operation of the safety cap removal tool 100. The nest block 108 may be formed from the baseplate 104, welded to the baseplate 104, adhered to the baseplate 104, and/or otherwise attached to the baseplate 104 via one or more fasteners such as socket head cap screws, bolts, or the like. In some examples, the nest block 108 may be attached directly to the contact surface 106 of the baseplate 104.

The safety cap removal tool 100 includes a pivot arm 116 that is pivotally attached to the baseplate 104 via a pin 112 that is attached to, or engaged with, the baseplate 104. The pin 112 may be formed from the baseplate 104, press fit into the baseplate 104, and/or otherwise attached to the baseplate 104. In some examples, the pin 112 may correspond to a shoulder screw having a pin body and a threaded end. The threaded end may be screwed into the baseplate 104 allowing the pin body to be exposed a vertical dimension from the contact surface 106 of the baseplate 104. In this example, the head of the shoulder screw may constrain movement of the pivot arm 116 relative to the baseplate 104 in the Y-axis direction, while still allowing rotational movement (e.g., about the Y-axis) of the pivot arm 116 relative to the baseplate 104.

The pivot arm 116 may comprise an arm length extending from a pivot end 118A of the pivot arm 116 to a handle end 118B of the pivot arm 116. The pivot end 118A may include a hole that rotationally engages with the pin 112 of the baseplate 104. In some examples, the pin 112 may be embedded or attached to the pivot arm 116, which is then inserted into a corresponding hole in the baseplate 104. In any event, the pinned coupling between the pivot arm 116 and the baseplate 104 allows rotation of the pivot arm 116 about the axis of the pin 112. In one example, the pivot arm 116 may include a slot 136 formed in the body of the pivot arm 116 between the pivot end 118A and the handle end 118B. The slot 136 may restrict rotational movement of the pivot arm 116 relative to the baseplate 104 to a maximum and minimum opening size. For instance, a thumbscrew 132 may be engaged with the baseplate 104 through the slot 136 of the pivot arm 116. More specifically, a body portion 134 of the thumbscrew 132 (e.g., threaded portion or shaft) may pass through the slot 136 and attach to or threadedly engage with the baseplate 104, while the head of the thumbscrew 132 constrains movement of the pivot arm 116 in the vertical direction (e.g., in the Y-axis direction). In this example, as the pivot arm 116 rotates clockwise relative to the baseplate 104 (when viewed in plan), the first end 336A of the slot 136 restricts movement of the pivot arm 116 beyond a first distance, D1, from the nest block 108 (e.g., as shown in FIG. 3A). Continuing this example, as the pivot arm 116 rotates counterclockwise relative to the baseplate 104 (when viewed in plan), the second end 336B of the slot 136 restricts movement of the pivot arm 116 beyond a second distance, D2, from the nest block 108 (e.g., as shown in FIG. 3B). In some examples, the first distance, D1, may correspond to a maximum opening distance for the circle 304 when the pivot arm 116 is in an open state 300A, and the second distance, D2, may correspond to a minimum open distance (or closed distance) for the circle 304 when the pivot arm 116 is in a closed state 300B. In this manner, the pivot arm 116 may be moved between a partially-to-fully opened state that accommodates larger child-resistant safety caps and a partially-to-fully closed state that accommodates smaller child-resistant safety caps. In one example, the slot 136 may prevent movement of the pivot arm 116 from directly contacting the nest block 108 of the safety cap removal tool 100.

A lip 124 is arranged to extend from a clamp surface 126 of the pivot arm 116, an engagement distance, De, into a receiving space 120 of the safety cap removal tool 100. The receiving space 120 may be arranged between the pivot arm 116 and the nest block 108. The receiving space 120 provides an area where the child-resistant safety cap of a bottle can be placed for removal of the outermost cap from the child-resistant safety cap by the safety cap removal tool 100. In some examples, the lip 124 may be formed as part of the pivot arm 116. In one example, the lip 124 may correspond to the outer peripheral edge of a screw 128, such as a socket head cap screw, a button head cap screw, a bolt, or the like, that is screwed into the pivot arm 116. The engagement distance, De, of the lip 124 provides an amount of material that is arranged to engage with an outer portion, periphery, or edge of the outermost cap of a child-resistant safety cap, for example, without contacting the innermost cap of the child-resistant safety cap. In particular, the lip 124 is arranged to hold the edge of the outermost cap against the contact surface 106 of the safety cap removal tool 100 when the child-resistant safety cap is clamped in the receiving space 120 between the clamp surface 126 and the nest block 108 of the safety cap removal tool 100.

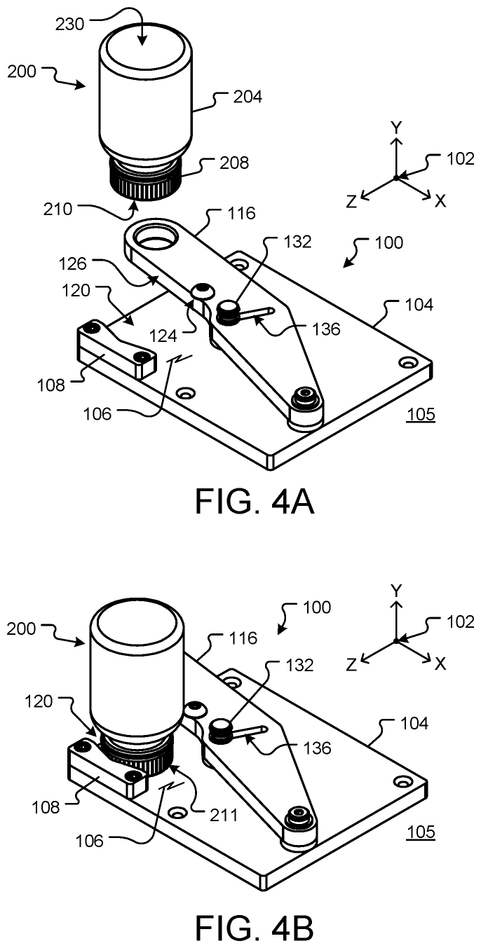

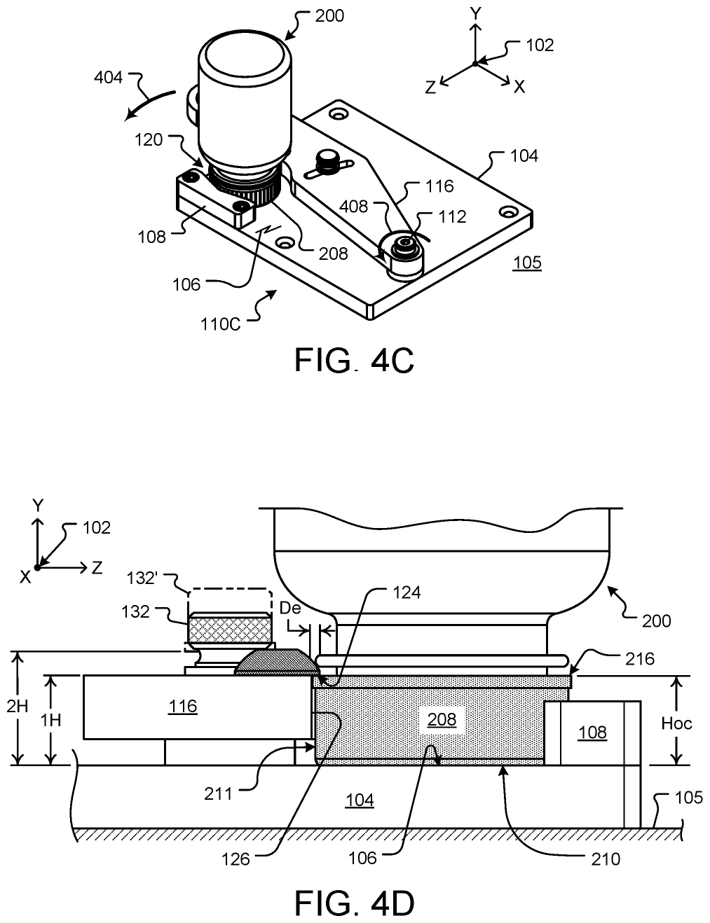

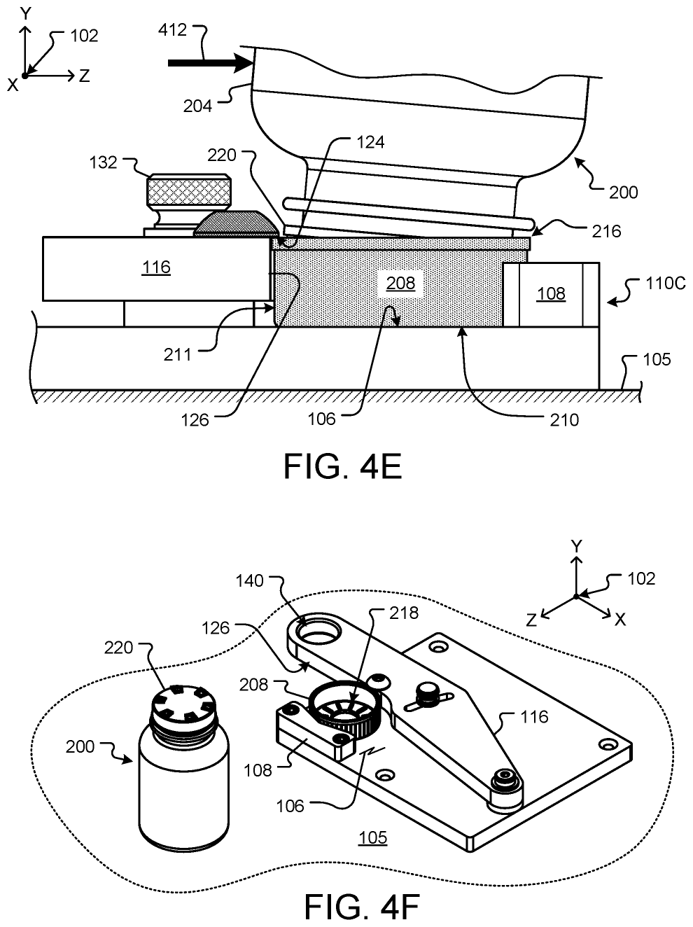

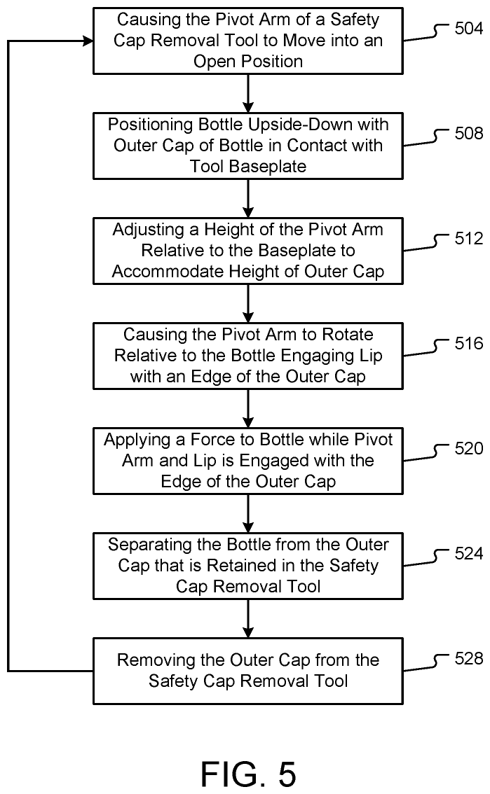

The pivot arm 116 includes an aperture 140 arranged at the handle end 118B. The aperture 140 provides a recess or through-hole where a user can grasp the pivot arm 116 when moving the pivot arm 116 pivotally about the pin 112. Although shown as an opening in the pivot arm 116, the aperture 140 may be used to attach a handle (e.g., extending in the Y-axis direction) or clevis of an actuator such as an air cylinder, solenoid, linear actuator, or screw actuator. The aperture 140 may include one or more chamfers or radiuses that provide an ergonomic engagement interface for a user. The handle end 118B of the pivot arm 116 is arranged outside of a periphery of the baseplate 104 at the first side 110A. In addition to the benefit of providing a longer lever arm, or arm length dimension, for the pivot arm 116, which increases the mechanical advantage of the pivot arm 116, the handle end 118B provides the aperture 140 in an area that is clear of obstruction making grasping by a user more efficient. Additional details of the safety cap removal tool 100 are described in relation to FIGS. 4A-5 below.

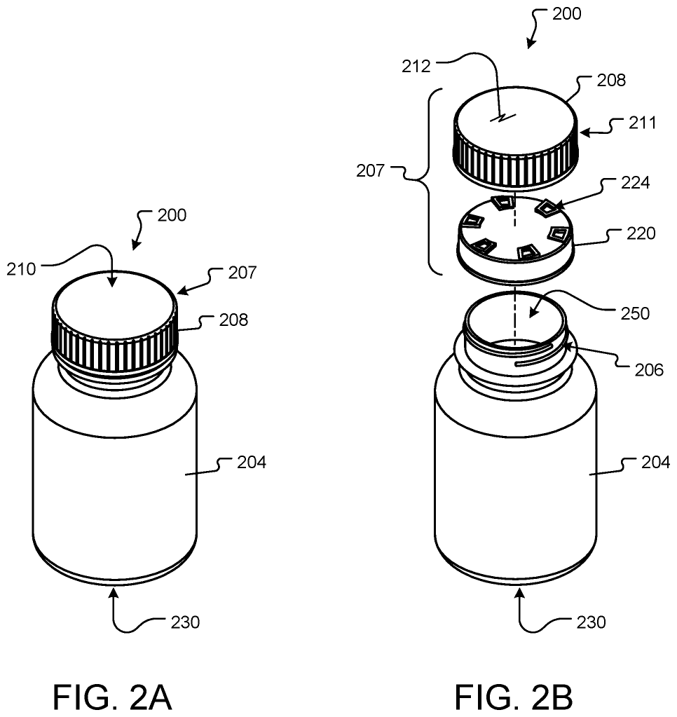

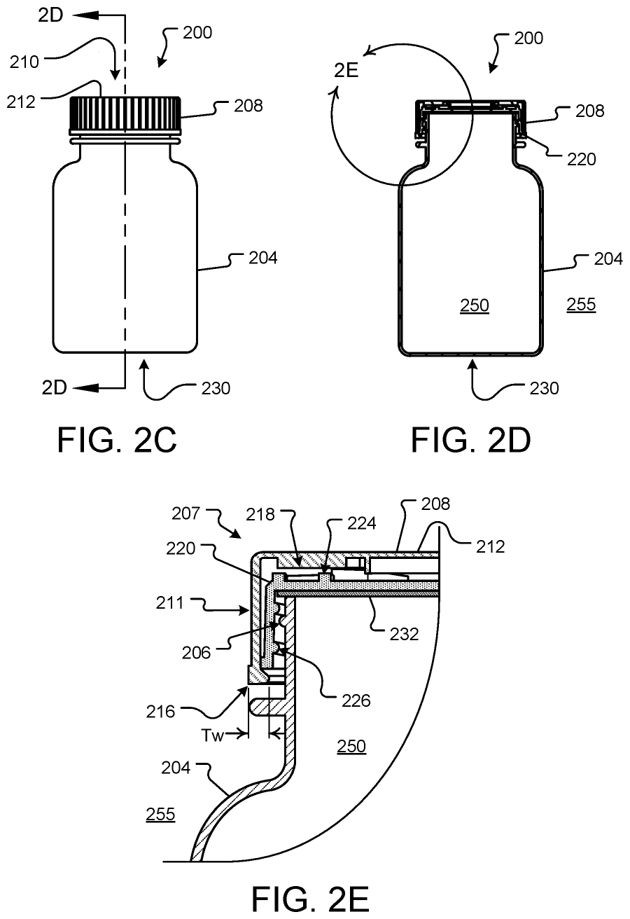

FIGS. 2A-2E show various views of a bottle 200 with a child-resistant safety cap 207 in accordance with examples of the present disclosure. In some examples, this arrangement may be referred to as the child-resistant safety cap bottle. Reference may be made herein to a top end 210 and a bottom end 230 of the bottle 200. The top end 210 may refer to an end of the bottle 200 where the child-resistant safety cap 207 attaches to the body 204 of the bottle 200. The bottom end 230 may refer to the base of the bottle 200. The bottle 200 generally includes a body 204 and a child-resistant safety cap 207 attached to a threaded end of the body 204. The child-resistant safety cap 207 may include an outermost cap 208 and an innermost cap 220. The outermost cap 208 includes a generally cylindrical surface 211 and a top surface 212. The outermost cap 208 couples with the innermost cap 220 such that the innermost cap 220 is circumferentially captured by a ledge 216, or outermost cap bumper, that surrounds the innermost cap 220. The outermost cap 208 is allowed to rotationally spin relative to the innermost cap 220 unless the outermost cap 208 is engaged with the innermost cap 220 by pressing the outermost cap 208 against the innermost cap 220 in the vertical dimension (as viewed from FIGS. 2C and 2D).

Referring to FIG. 2E, a detail section view of the bottle 200 with the child-resistant safety cap 207 is taken from circle “2E” of FIG. 2D. The detail section view of FIG. 2E shows the body 204 of the bottle 200 including an interior volume 250 that is separate from the exterior 255 of the bottle 200. The child-resistant safety cap 207 is shown to include an innermost cap 220 that is attached to the body 204 by a threaded interface between the internal threads 226 of the innermost cap 220 and the external threads 206 of the body 204. In some examples, a gasket 232 may be disposed between the innermost cap 220 and the body 204. In one example, the gasket 232 may correspond to a felt, cardboard, foil, or other type of seal. This gasket 232 may provide an air and/or water-tight seal between the interior volume 250 and the exterior 255 of the bottle 200 when the innermost cap 220 is fastened to the body 204 of the bottle 200. In some examples, the gasket 232 may be a part of the child-resistant safety cap 207. For instance, the gasket 232 may be made from a material that functions as a flat disk spring between the innermost cap 220 and top portion of the mouth of the body 204 of the bottle 200. In some applications, a specific tightening torque may be required to twist the outermost cap 208 with a push-down pressure that tightens the child-resistant safety cap 207 onto the body 204 of the bottle 200 via the threaded interface (e.g., between the internal threads 226 of the innermost cap 220 and the external threads 206 of the body 204 of the bottle 200). In these applications, the three pieces of the child-resistant safety cap 207 (e.g., the gasket 232, the innermost cap 220, and the outermost cap 208) may work together to provide an adequate fastening to the body 204 of the bottle 200. In one example, the gasket 232 may be referred to as a “liner” herein and may correspond to any type of liner that is used in the closure industry. The liner, or gasket 232, may be configured to provide a spring force for maintaining a range of torque required to secure the child-resistant safety cap 207 onto the bottle 200 without incidental unwanted removal during shipping and/or general handling.

As described above, the outermost cap 208 may rotate about the axis of the bottle 200 relative to the innermost cap 220 unless the outermost cap 208 is moved into a vertically engaged position with the innermost cap 220. In particular, the outermost cap 208 may be moved in a downward vertical direction (as viewed in the arrangement of FIG. 2E), such that one or more teeth or safety engagement protrusions 218 are disposed in contact with the safety lock features 224 of the innermost cap 220. The safety lock feature 224 may correspond to ramped protrusions that do not allow torque to be transmitted from the outermost cap 208 to the innermost cap 220 unless a vertical portion of a safety engagement protrusion 218 is engaged with and/or disposed in contact with a corresponding vertical portion of a safety lock feature 224. Once engaged, a loosening torque applied to the outermost cap 208 may be passed from the outermost cap 208 to the innermost cap 220 causing the innermost cap 220 to unscrew from the bottle 200.

The outermost cap 208 is shown as including a cylindrical surface 211 surrounding the circumference of the outermost cap 208. The cylindrical surface 211 provides an area or region by which the outermost cap 208 can be grasped. The cylindrical surface 211 may extend from the top surface 212 of the outermost cap 208 to the ledge 216 of the outermost cap 208. The ledge 216 is disposed, vertically, beneath the innermost cap 220 of the child-resistant safety cap 207. The ledge 216 extends toward a center of the bottle 200 and provides a wall thickness, Tw, that captures or retains the outermost cap 208 in a vertical arrangement with the innermost cap 220. Stated another way, the ledge 216 prevents unwanted or inadvertent removal or separation of the outermost cap 208 from the innermost cap 220. The safety cap removal tool 100 provides a lip 124 that engages with the wall thickness, Tw, of the ledge 216 and allows the outermost cap 208 to be separated from the innermost cap 220 by focusing a separation force on the outermost cap 208 and not on the innermost cap 220.

FIG. 3A shows the safety cap removal tool 100 in an open state 300A in accordance with examples of the present disclosure. The safety cap removal tool 100 allows the pivot arm 116 to be rotated about the pin 112 to adjust a circle 304 size for receiving a child-resistant safety cap 207 of a bottle 200. In FIG. 3A, the pivot arm 116 is separated from the nest block 108 by a first distance, D1, providing a large diameter of the circle 304 to accommodate bottles 200 having larger child-resistant safety caps 207.

FIG. 3B shows the safety cap removal tool 100 in a closed state 300B in accordance with examples of the present disclosure. In FIG. 3B, the pivot arm 116 is separated from the nest block 108 by a second distance, D2, providing a small diameter of the circle 304 to accommodate bottles 200 having smaller child-resistant safety caps 207. The pivot arm 116 may be restricted from contacting the nest block 108 by the first end 336A and second end 336B of the slot 136 and the thumbscrew 132 engagement.

The circle 304 shown in FIGS. 3A and 3B may correspond to the cylindrical surface 211 of an outermost cap 208 of a child-resistant safety cap 207. The circle 304 is arranged in the receiving space 120 of the safety cap removal tool 100 such that a portion of the circle 304 contacts a first surface 308A and a second surface 308B of the nest block 108 and the clamp surface 126 of the pivot arm 116. In this manner, when a child-resistant safety cap 207 is positioned in the receiving space 120 such that the top surface 212 of the outermost cap 208 contacts the contact surface 106 and a portion of the cylindrical surface 211 is arranged in contact with the first surface 308A and second surface 308B of the nest block 108, the pivot arm 116 may be caused to rotate (e.g., about the pin 112) such that the clamp surface 126 directly contacts the cylindrical surface 211 of the outermost cap 208. The first surface 308A and second surface 308B may serve as a self-centering feature for the cylindrical surface 211 of the outermost cap 208 placed in the receiving space 120 of the safety cap removal tool 100. Further, the first surface 308A of the nest block 108, the second surface 308B of the nest block 108, and the clamp surface 126 of the pivot arm 116 at least provide a three-point contact between the safety cap removal tool 100 and the cylindrical surface 211 of the outermost cap 208 when clamped in the receiving space 120. Among other things, this three-point contact provides support for the outermost cap 208 and bottle 200 when performing the separation of the outermost cap 208 from the innermost cap 220 of the child-resistant safety cap 207.

FIGS. 4A-4F show various views of the safety cap removal tool 100 during an operation of removing an outermost cap 208 from a child-resistant safety cap 207 in accordance with examples of the present disclosure. In FIG. 4A, the safety cap removal tool 100 is shown in an open state 300A. In this position, the pivot arm 116 is moved to a position where the clamp surface 126 of the pivot arm 116 is separated from the nest block 108 by a first distance, D1, providing a large area, or receiving space 120, for accommodating the outermost cap 208 of the bottle 200. In this position, the bottle 200 is positioned upside-down such that the top end 210 of the bottle 200 faces the contact surface 106 of the baseplate 104.

In FIG. 4B, the bottle 200 is moved into the receiving space 120 such that the top surface 212 of the outermost cap 208 is arranged in direct contact with the contact surface 106 of the baseplate 104 in the receiving space 120. The cylindrical surface 211 of the outermost cap 208 is placed into contact with the nest block 108 (e.g., such that the cylindrical surface 211 contacts the first surface 308A and the second surface 308B of the nest block 108, shown in FIGS. 3A-3B). In some examples, a user may hold the bottle 200 against the safety cap removal tool 100 by applying a force to the bottom end 230 of the bottle 200 in a direction toward the baseplate 104.

In FIG. 4C, the pivot arm 116 is caused to rotate in a first direction 408 such that the handle end 118B of the pivot arm 116 moves in a movement direction 404 toward the nest block 108. As the pivot arm 116 rotates in the first direction 408, the clamp surface 126 of the pivot arm 116 comes into contact with the cylindrical surface 211 of the outermost cap 208. The cylindrical surface 211 may include any one or more portions of the outer peripheral surface of the outermost cap 208.

FIG. 4D shows a detail side elevation section view of the safety cap removal tool 100 and bottle 200 with the child-resistant safety cap 207 shown in FIG. 4C (e.g., viewed from the first side 110A of the baseplate 104). As illustrated in FIG. 4D, the lip 124 of the pivot arm 116 is engaged with the ledge 216 of the outermost cap 208 while the outermost cap 208 is captured between the clamp surface 126 and the nest block 108. In this position, the lip 124 extends an engagement distance, De, over a portion of the wall thickness, Tw, of the ledge 216. In one example, the engagement distance, De, may be dimensioned less than or equal to the wall thickness, Tw, of the ledge 216. This sizing may ensure that the lip 124 engages with, or overlaps, the ledge 216 of the outermost cap 208 without contacting the innermost cap 220 of the child-resistant safety cap 207 during operation.

In some examples, the pivot arm 116 may be adjusted (e.g., in the Y-axis direction) to accommodate various heights of child-resistant safety caps 207. For instance, the outermost cap 208 may include an outermost cap height, Hoc, extending from the top surface 212 of the outermost cap 208 to the ledge 216 of the outermost cap 208. By rotating the thumbscrew 132 relative to the baseplate 104, the head of the thumbscrew 132 may be moved from a first height, 1H, offset from the contact surface 106 to a second height, 2H, offset from the contact surface 106. When the thumbscrew 132 is caused to move upward, in the Y-axis direction, to the higher thumbscrew position 132′, the pivot arm 116 and lip 124 move from the first height, 1H, to the second height, 2H. In one example a spring may be disposed between the pivot arm 116 and the baseplate 104 to allow the pivot arm 116 to move away from the baseplate 104 until constrained by the vertical position of the thumbscrew 132.

FIG. 4E shows a detail side elevation section view of the safety cap removal tool 100 and bottle 200 with the child-resistant safety cap 207 shown in FIG. 4D, in a first separation condition. In FIG. 4E, while the outermost cap 208 is clamped between the pivot arm 116 and the nest block 108, and the lip 124 is engaged with (e.g., overlapping) the ledge 216 of the outermost cap 208, a separation force 412 may be applied to the body 204 of the bottle 200. The separation force 412 may be applied to the body 204 of the bottle 200 near the bottom end 230 of the bottle 200 to provide increased mechanical advantage (e.g., increasing the lever arm distance between the contact point for the separation force 412 and the contact surface 106 of the baseplate 104). The separation force 412 may be applied in a direction along the Z-axis, or in the YZ-plane, such that the bottom end 230 of the body 204 of the bottle 200 is moved in a direction toward the third side 110C of the baseplate 104. As the separation force 412 is applied, the innermost cap 220 pivots at a point near the nest block 108 and begins to separate from the ledge 216 of the outermost cap 208. This initial separation of the innermost cap 220 from the outermost cap 208 is shown in the detail section view of FIG. 4E.

FIG. 4F shows a perspective view of the safety cap removal tool 100 with the outermost cap 208 retained in the receiving space 120 while the bottle 200 with innermost cap 220 has been separated therefrom. Once the outermost cap 208 has been removed or separated from the innermost cap 220, the pivot arm 116 may be caused to rotate about the pin 112 in a second direction that is opposite the first direction 408 (shown in FIG. 4C), releasing the outermost cap 208 of the child-resistant safety cap 207 of the bottle 200 from the safety cap removal tool 100. With the outermost cap 208 removed from the innermost cap 220, the bottle 200 can be easily opened by directly unscrewing the innermost cap 220. Stated another way, the bottle 200 can be opened without the child-resistant safety features offered by the outermost cap 208. While the non-child-resistant bottles 200 shown in FIG. 4F should never be within reach of a child, the non-child-resistant bottles 200 can be provided to senior citizens, those with arthritis, or to other users with disabilities to allow easy opening of their medication without requiring demanding or uncomfortable tactile functionality to do so.

FIG. 5 is a flow diagram of a method for removing an outermost cap 208 from a child-resistant safety cap 207 in accordance with examples of the present disclosure. The method begins by providing a safety cap removal tool 100 as described above. Next, the pivot arm 116 of the safety cap removal tool 100 is caused to move into an open position, such as the position shown in the open state 300A of FIG. 3A (step 504). For instance, the pivot arm 116 may be actuated by a person rotating the pivot arm 116 by the handle end 118B and/or the aperture 140 moving the clamp surface 126 of the pivot arm 116 away from the nest block 108. In one example, an actuator may be used to automatically open the pivot arm 116 in this step. Opening the pivot arm 116 provides allows the receiving space 120 to be positioned to receive a portion of a child-resistant safety cap 207.

The method continues by positioning a bottle 200 upside-down such that the top surface 212 of the outermost cap 208 is arranged facing the contact surface 106 of the baseplate 104 (step 508). This step is generally shown in the arrangement illustrated in FIG. 4A. A user may grasp the bottle 200 at or near the bottom end 230 of the bottle 200 when inverting the bottle 200 in this step.

In some examples, the method may include adjusting a height of the pivot arm 116 relative to the baseplate 104 to accommodate a specific outermost cap height, Hoc (step 512). In this step, the thumbscrew 132 may be loosened or unscrewed such that the head of the thumbscrew 132 moves away from the contact surface 106 of the baseplate 104 or screwed further into the baseplate 104 such that the head of the thumbscrew 132 moves toward the contact surface 106 of the baseplate 104. As shown in FIG. 4D, the pivot arm 116 may be moved from a first height, 1H, to a second height, 2H, by adjusting the height of the thumbscrew 132. The adjustment of the height of the pivot arm 116 (e.g., to closely match the outermost cap height, Hoc) causes the distance between the contact surface 106 and the lip 124 to better match or engage with the ledge 216 of the outermost cap 208.

Next, the method continues by causing the pivot arm 116 to rotate (e.g., in the first direction 408) such that the lip 124 engages with the ledge 216 of the outermost cap 208 (step 516). In particular, the lip 124 is moved such that a portion of the lip 124 extending from the clamp surface 126 an engagement distance, De, overlaps a portion of the wall thickness, Tw, of the ledge 216. In this position, the engagement distance, De, is equal to or less than the wall thickness, Tw, ensuring that the lip 124 will contact the ledge 216 without contacting any part of the innermost cap 220. While in this position, the outermost cap 208 (e.g., the cylindrical surface 211 of the outermost cap 208) is captured, or clamped, between the clamp surface 126 of the pivot arm 116 and the first surface 308A and second surface 308B of the nest block 108. Further, the outermost cap 208 is prevented from moving apart from the contact surface 106 by the lip 124 engaged with the ledge 216.

While the outermost cap 208 is clamped in the receiving space 120 by the pivot arm 116 and the nest block 108, a separation force 412 may be applied to a portion of the bottle 200 (step 520). The separation force 412 may be applied to the body 204 of the bottle 200 moving the bottle in a direction toward the third side 110C of the baseplate 104. The separation force 412 may be applied to the body 204 of the bottle 200 at the bottom end 230 of the bottle 200 with one hand while another hand maintains a clamping force on the pivot arm 116 acting in the movement direction 404. As the separation force 412 is applied to the bottle 200, the bottle 200 and the innermost cap 220 begin to separate from the outermost cap 208 held by the lip 124 and the safety cap removal tool 100. This initial separation is illustrated in FIG. 4E.

Next, the separation force 412 may continue to be applied to the bottle 200 until the outermost cap 208 is completely separated from the bottle 200 and the innermost cap 220 (step 524). FIG. 4F shows a perspective view of the bottle 200 and the innermost cap 220 separated from an outermost cap 208 that is retained in the receiving space 120 of the safety cap removal tool 100. The outermost cap 208 may be removed from the receiving space 120 by moving the pivot arm 116 in a direction opposite the first direction 408 causing the pivot arm 116 to move away from the nest block 108 of the safety cap removal tool 100 (step 528). At this point, the method may be repeated for additional bottles 200 that require removal of the outermost cap 208 from the innermost cap 220 of the child-resistant safety cap 207, converting the child-resistant safety bottles into non-child resistant bottles.

As should be appreciated by one skilled in the art, aspects of the present disclosure have been illustrated and described herein in any of a number of patentable classes or context including any new and useful process, machine, manufacture, or composition of matter, or any new and useful improvement thereof.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X1-Xn, Y1-Ym, and Z1-Zo, the phrase is intended to refer to a single element selected from X, Y, and Z, a combination of elements selected from the same class (e.g., X1 and X2) as well as a combination of elements selected from two or more classes (e.g., Y1 and Zo).

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein.

A number of implementations have been described. Nevertheless, it will be understood that additional modifications may be made without departing from the scope of the inventive concepts described herein, and, accordingly, other examples are within the scope of the following claims.

What is claimed is:

1. A safety cap removal tool, comprising:
a baseplate, comprising:
a first side;
a second side that is offset from the first side by a width of the baseplate; and
a contact surface arranged between the first side and the second side;
a nest block attached to the baseplate adjacent the first side;
a pin attached to the baseplate adjacent the second side of the baseplate;
a pivot arm comprising an arm length, the arm length extending from a pivot end of the pivot arm to a handle end of the pivot arm, the pivot arm pivotally engaged with the pin at the pivot end of the pivot arm, wherein the handle end of the pivot arm is arranged outside of a periphery of the baseplate at the first side, and wherein a receiving space is arranged between the pivot arm and the nest block; and
a lip extending from a surface of the pivot arm into the receiving space;
wherein the pivot arm is moveable about the pin between an open state of the pivot arm and a closed state of the pivot arm, wherein, in the open state of the pivot arm, the pivot arm is spaced apart from the nest block by a first distance, wherein, in the closed state of the pivot arm, the pivot arm is spaced apart from the nest block by a second distance, and wherein the second distance is less than the first distance.

2. The safety cap removal tool of claim 1, wherein the lip corresponds to a portion of a head of a screw that is attached to the pivot arm, and wherein the lip extends an engagement distance from the surface of the pivot arm.

3. The safety cap removal tool of claim 2, further comprising:
a thumbscrew engaged with the baseplate at a point between the first side and the second side, wherein a body portion of the thumbscrew engages with a slot disposed in a thickness of the pivot arm at a point between the pivot end of the pivot arm and a handle end of the pivot arm.

4. The safety cap removal tool of claim 3, wherein, in the open state of the pivot arm, the body portion of the thumbscrew engages with a first end of the slot, wherein, in the closed state of the pivot arm, the body portion of the thumbscrew engages with a second end of the slot, and wherein the first end of the slot is disposed opposite the second end of the slot.

5. The safety cap removal tool of claim 4, wherein the pin is a shoulder screw and wherein the pivot arm is captured relative to the baseplate by a head of the shoulder screw.

6. The safety cap removal tool of claim 4, wherein the pivot arm further comprises:
an aperture passing through the thickness of the pivot arm adjacent the handle end of the pivot arm.

7. The safety cap removal tool of claim 4, wherein the nest block comprises a V-shaped recess, and wherein a circle arranged in the receiving space contacts a first surface of the V-shaped recess, a second surface of the V-shaped recess and the surface of the pivot arm when the pivot arm is in the open state of the pivot arm and when the pivot arm is in the closed state of the pivot arm.

8. The safety cap removal tool of claim 7, wherein the circle coincides with an outer cylindrical surface of a child-resistant safety cap of a bottle disposed in the receiving space such that a top surface of the child-resistant safety cap of the bottle is arranged in direct contact with the contact surface of the baseplate.

9. The safety cap removal tool of claim 8, wherein the child-resistant safety cap of the bottle comprises:
an innermost cap that threadedly engages with the bottle; and
an outermost cap that selectively engages with the innermost cap, wherein the engagement distance is sized to a dimension that is less than or equal to a thickness of a wall of the outermost cap.

10. The safety cap removal tool of claim 9, wherein, when the child-resistant safety cap of the bottle is arranged in contact with the contact surface, the pivot arm, and the nest block, the lip is arranged in contact with the outermost cap, and the bottle and the innermost cap are unrestricted by the safety cap removal tool.

11. The safety cap removal tool of claim 10, wherein the thumbscrew is rotatable between a first height and a second height that is configured to be set to a height of the outermost cap.

12. A safety cap removal tool, comprising:
a baseplate comprising a width extending from a first side of the baseplate to a second side of the baseplate and a height extending from a third side of the baseplate to a fourth side of the baseplate;
a nest block attached to a surface of the baseplate, the nest block arranged adjacent the first side of the baseplate and the third side of the baseplate;
a pivot arm comprising a length extending from a pivot end of the pivot arm to an actuation end of the pivot arm, the pivot arm rotationally engaged with the baseplate at a pivot disposed at the pivot end of the pivot arm, wherein the pivot is arranged adjacent the second side of the baseplate;
a safety cap receiving space disposed between the pivot arm and the nest block, the safety cap receiving space inset from the width of the baseplate a dimension from the first side and a dimension from the third side of the baseplate; and
a lip extending a distance from the pivot arm into the safety cap receiving space, the distance corresponding to a wall thickness of an outermost cap of a child-resistant safety cap of a bottle.

13. The safety cap removal tool of claim 12, wherein the pivot arm is moveable between an open position relative to the nest block and a closed position relative to the nest block, wherein, an area of the safety cap receiving space in the open position is greater than an area of the safety cap receiving space in the closed position.

14. The safety cap removal tool of claim 13, wherein the safety cap receiving space defines clamping surfaces of the safety cap removal tool corresponding to the surface of the pivot arm and at least one surface of the nest block.

15. The safety cap removal tool of claim 14, wherein the clamping surfaces are configured to contact a cylindrical surface of the outermost cap of the child-resistant safety cap of the bottle at least at opposite sides of the cylindrical surface when the outermost cap of the child-resistant safety cap of the bottle is disposed in the safety cap receiving space and in contact with the surface of the baseplate.

16. The safety cap removal tool of claim 15, wherein the lip is a portion of a head of a screw that is attached to the pivot arm.

17. The safety cap removal tool of claim 15, wherein the actuation end of the pivot arm comprises an aperture that passes completely through a thickness of the pivot arm.

18. A method of removing an outermost cap from a child-resistant safety cap, comprising:
providing a safety cap removal tool, comprising:
a baseplate comprising a width extending from a first side of the baseplate to a second side of the baseplate and a height extending from a third side of the baseplate to a fourth side of the baseplate;
a nest block attached to a surface of the baseplate, the nest block arranged adjacent the first side of the baseplate and the third side of the baseplate;
a pivot arm comprising a length extending from a pivot end of the pivot arm to an actuation end of the pivot arm, the pivot arm rotationally engaged with the baseplate at a pivot disposed at the pivot end of the pivot arm, wherein the pivot is arranged adjacent the second side of the baseplate;
a receiving space disposed between the pivot arm and the nest block, the receiving space inset from the width of the baseplate a dimension from the first side and inset from the width of the baseplate a dimension from the third side of the baseplate; and
a lip extending a distance from the pivot arm into the receiving space;
positioning a child-resistant safety cap of a bottle into the receiving space of the safety cap removal tool such that a top surface of the child-resistant safety cap is disposed in contact with the surface of the baseplate and a cylindrical surface of the child-resistant safety cap of the bottle is disposed in contact with the nest block;
causing the pivot arm to rotate about the pivot in a first direction and contact the cylindrical surface of the child-resistant safety cap of the bottle clamping the child-resistant safety cap of the bottle between the pivot arm and the nest block, wherein the lip extends the distance over a wall thickness of an outermost cap of the child-resistant safety cap of the bottle; and
applying a force to the bottle such that the bottle and an innermost cap of the bottle separate from the outermost cap of the child-resistant safety cap of the bottle.

19. The method of claim 18, wherein, prior to causing the pivot arm to rotate, the method comprises:
adjusting a height of the pivot arm relative to the baseplate via a thumbscrew engaged with the baseplate at a point between the first side of the baseplate and the second side of the baseplate, wherein a body portion of the thumbscrew engages with a slot disposed in a thickness of the pivot arm at a point between the pivot end of the pivot arm and the actuation end of the pivot arm.

20. The method of claim 19, further comprising:
removing the outermost cap of the bottle from the receiving space of the safety cap removal tool; and
causing the pivot arm to rotate about the pivot in a second direction opposite the first direction, releasing the outermost cap of the child-resistant safety cap of the bottle from the safety cap removal tool.
